(19) United States
(12) Patent Application Publication
(10) Pub. No.: US 2008/0301171 A1
(43) Pub. Date: Dec. 4, 2008

(54) Methods, Systems, and Computer-Readable Media for Generating XML Files from Mainframe Data

(76) Inventors: Eugene Owen, JR., Alabaster, AL (US); Jeffrey Graham, Leeds, AL (US); Michael Warren, Birmingham, AL (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/755,874

(22) Filed: May 31, 2007

(51) Int. Cl. G06F 7/00

(52) U.S. Cl. 707/102; 707/E17.01

(57) ABSTRACT

Methods, systems, and computer-readable media provide for generating XML files from mainframe data. According to embodiments, a method for generating Extensible Markup Language (XML) files from mainframe data is provided. According to the method, at least one mainframe data file is received. Data is extracted from the at least one mainframe data file according to at least one selection criteria. At least one XML tag is appended to the extracted data to generate at least one XML file.

### TECHNICAL FIELD

This application relates generally to the field of XML file generation. More specifically, the disclosure provided herein relates to the field of generating XML files from mainframe data.

### BACKGROUND

Electronic documents typically include text, audio, video, multimedia, and other data for expressing information contained in the data. To enrich the data with additional information for processing, markup may be added to the electronic document. Markup generally refers to any suitable information that a user seeks to attribute to the data. For example, markup may be added to a spreadsheet document to attribute pre-defined fields to the associated data in the document.

Oftentimes electronic documents contain large amounts of unorganized data, which may be obtained from data mining and other data gathering operations. One way to organize these large data sets is to store them in a database. Databases are generally capable of storing large data sets in a structured and organized manner such that a user can easily retrieve specific information from the database through queries.

Businesses commonly utilize mainframes to automate what would otherwise be labor-intensive and computationally-intensive tasks, such as payroll and billing, especially for large organizations. The processing performed by mainframes may generate large and unorganized data sets (i.e., mainframe data). Preparing the mainframe data for storage in a database presents a significant problem. In particular, the users utilizing the mainframe data, such as office personnel, may not be sufficiently knowledgeable about databases to build and populate a database with the mainframe data.

### SUMMARY

Embodiments of the disclosure presented herein include methods, systems, and computer-readable media for generating XML files from mainframe data. According to one aspect, a method for generating Extensible Markup Language (XML) files from mainframe data is provided. According to the method, at least one mainframe data file is received. Data is extracted from the at least one mainframe data file according to at least one selection criteria. At least one XML tag is appended to the extracted data to generate at least one XML file.

According to another aspect, a system for generating Extensible Markup Language (XML) files from mainframe data is provided. The system includes a memory and a processor functionally coupled to the memory. The memory stores a program containing code for generating XML files from mainframe data. The processor is responsive to computer-executable instructions contained in the program and operative to receive at least one mainframe data file, extract data from the at least one mainframe data file according to at least one selection criteria, and append at least one XML tag to the extracted data to generate at least one XML file.

According to yet another aspect, a computer-readable medium having instructions stored thereon for execution by a processor to perform a method for generating Extensible Markup Language (XML) files from mainframe data is provided. According to the method, at least one mainframe data file is received. Data is extracted from the at least one mainframe data file according to at least one selection criteria. At least one XML tag is appended to the extracted data to generate at least one XML file.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating a system configured to generate XML files from mainframe data, in accordance with exemplary embodiments.

FIG. 2 is a block diagram illustrating an operation of the XML file generation module, in accordance with exemplary embodiments.

FIG. 3 is a block diagram illustrating the XML file generation module, in accordance with exemplary embodiments.

FIG. 4 is a flow diagram illustrating a method of generating the XML files from the mainframe data files, in accordance with exemplary embodiments.

### DETAILED DESCRIPTION

The following detailed description is directed to methods, systems, and computer-readable media for generating XML files from mainframe data. In the following detailed description, references are made to the accompanying drawings that form a part hereof, and which are shown by way of illustration specific embodiments or examples.

Mainframes can generate and acquire large amounts of unorganized data (hereinafter “mainframe data”). Mainframe data may include, but is not limited to, personnel data, customer data, manufacturing data, sales data, payroll data, and billing data. In one embodiment, mainframe data is stored in one or more digital files, such as, but not limited to, flat files. As described herein, the digital files containing the mainframe data are generally not suitable for prepopulating a database due, at least in part, to the unorganized nature of the mainframe data. Illustrative embodiments described herein enable the generation of Extensible Markup Language (“XML”) files from the one or more digital files containing the unorganized data. The generated XML files are suitable for dynamic use in one or more of: prepopulating a database, later amending a database, and even deleting information from a database.

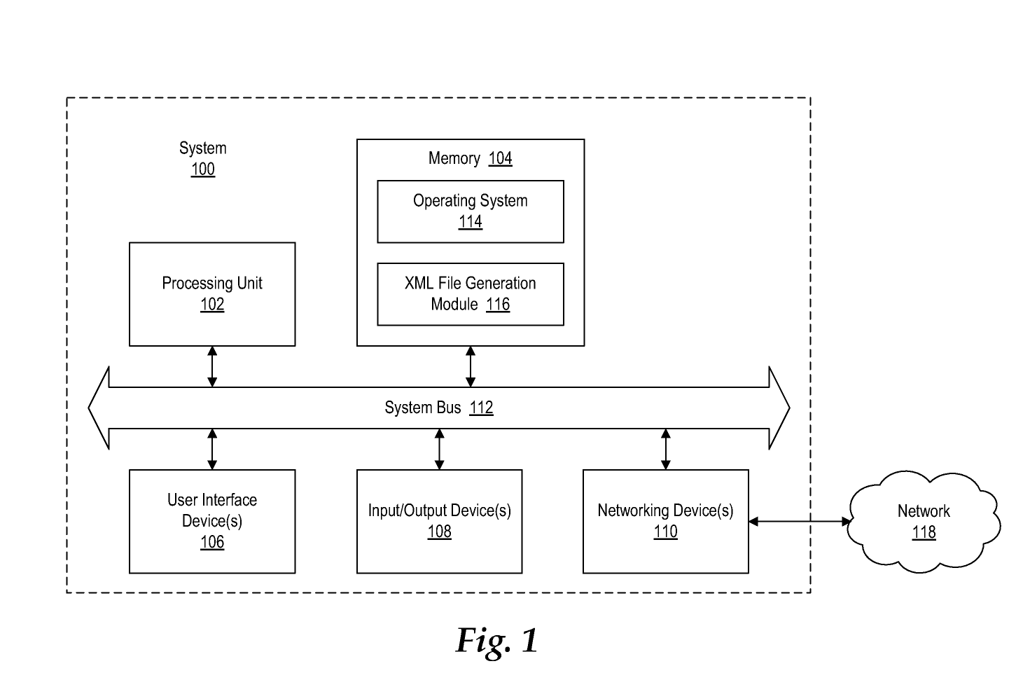

Referring now to the drawings, it is to be understood that like numerals represent like elements through the several figures, and that not all components and/or steps described and illustrated with reference to the figures are required for all embodiments. FIG. 1 and the following discussion are intended to provide a brief, general description of a suitable computing environment in which embodiments may be implemented. While embodiments will be described in the general context of program modules that execute in conjunction with an application program that runs on an operating system on a computer system, those skilled in the art will recognize that the embodiments may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

FIG. 1 is a block diagram illustrating a system 100 configured to generate XML files from mainframe data, in accordance with exemplary embodiments. The system 100 includes a processing unit 102, a memory 104, one or more user interface devices 106, one or more input/output (“I/O”) devices 108, and one or more network devices 110, each of which is operatively connected to a system bus 112. The bus 112 enables bi-directional communication between the processing unit 102, the memory 104, the user interface devices 106, the I/O devices 108, and the network devices 110. Examples of the system 100 include, but are not limited to, computers, servers, personal digital assistants, cellular phones, or any suitable computing devices.

The processing unit 102 may be a standard central processor that performs arithmetic and logical operations, a more specific purpose programmable logic controller (“PLC”), a programmable gate array, or other type of processor known to those skilled in the art and suitable for controlling the operation of the server computer. Processing units are well-known in the art, and therefore not described in further detail herein.

The memory 104 communicates with the processing unit 102 via the system bus 112. In one embodiment, memory 104 is operatively connected to a memory controller (not shown) that enables communication with the processing unit 102 via the system bus 112. The memory 104 includes an operating system 114 and an XML file generation module 116, according to exemplary embodiments. Examples of operating systems, such as operating system 114, include, but are not limited to, WINDOWS operating system from MICROSOFT CORPORATION, LINUX operating system, and FREEBSD operating system. In one embodiment, the XML file generation module 116 is embodied in computer-readable media containing instructions that, when executed by the processing unit 102, performs a method of generating XML files from mainframe data, as described in greater detail below. According to further embodiments, the XML file generation module 116 may be embodied in hardware, software, firmware, or any combination thereof.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the system 100.

The one or more I/O devices 108 enable a user to interface with the XML file generation module 116. In one embodiment, the one or more I/O devices 108 are operatively connected to an I/O controller (not shown) that enables communication with the processing unit 102 via the system bus 112. The one or more I/O devices 108 may include one or more input devices, such as, but not limited to, a keyboard, a mouse, or an electronic stylus. Further, the one or more I/O devices 108 may include one or more output devices, such as, but not limited to, a display screen or a printer.

The one or more network devices 110 enable the system 100 to communicate with other networks or remote systems via a network 118. Examples of network devices 110 may include, but are not limited to, a modem, a radio frequency (“RF”) or infrared (“IR”) transceiver, a telephonic interface, a bridge, a router, or a network card. The network 118 may include a wireless network such as, but not limited to, a Wireless Local Area Network (“WLAN) such as a WI-FT network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 118 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

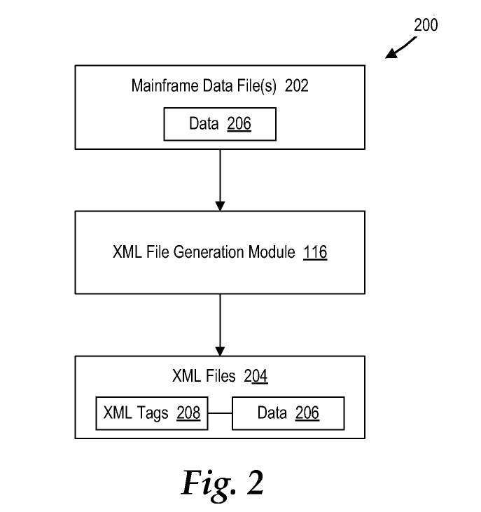

FIG. 2 is a block diagram illustrating an operation 200 of the XML file generation module 116, in accordance with exemplary embodiments. In the operation 200, the XML file generation module 116 may input one or more mainframe data files 202 and process the mainframe data files 202 received to generate one or more XML files 204. In one embodiment, the mainframe data files 202 received as input to the XML file generation module 116 are stored in the memory 104 of FIG. 1. According to further embodiments, the mainframe data files 202 are stored remotely from the system 100 and received by the system 100 via the network 118. The XML files 204 generated by the XML file generation module 116 may also be stored in the memory 104 of the system 100 and may be sent to other networks or remote systems via the network 118. According to further embodiments, the generated XML files 204 may be stored remotely from the system 100.

The mainframe data files 202 may include one or more sets of generally unorganized data, such as data 206. Examples of data contained in the mainframe data files 202 include, but are not limited to, personnel data, customer data, manufacturing data, sales data, payroll data, billing data, and any other suitable data. While the one or more data sets may contain some basic tags or other indications of data type or formatting, the one or more data sets are not suitable for prepopulating a database without further processing. In one embodiment, the one or more data sets are gathered from an INTERNATIONAL BUSINESS MACHINES MUTIPLE VIRTUAL STORAGE (“IBM MVS”) mainframe, such as the IBM OS/370 MVS mainframe. In further embodiments, the data sets are gathered from any suitable mainframe or other computing device. In one embodiment, one or more of the mainframe data files 202 are flat files. Examples of databases that may be populated with the data sets include, but are not limited to, OFFICE ACCESS from MICROSOFT CORPORATION, FILEMAKER from FILEMAKER CORPORATION, and ORACLE DATABASE from ORACLE CORPORATION.

The XML files 204 may comprise the one or more data sets, such as the data 206, in the mainframe data files 202. In the XML files 204, the data sets are appended with XML tags, such as XML tags 208, such that the XML files 204 are suitable for dynamic use in one or more of: prepopulating a database, later amending a database, and even deleting information from a database. Examples of XML tags 208 include, but are not limited to, metadata indicating that a sequence number is a telephone number. An exemplary tag that a data element as a telephone number is “<BTN>XXX-XXX-XXXX</BTN>.” In one embodiment, the XML tags 208 are provided by the end users. According to further embodiments, the XML tags 208 are retrieved from the data 206 themselves. The XML tags 208 may also be provided by a remote system via the network 118.

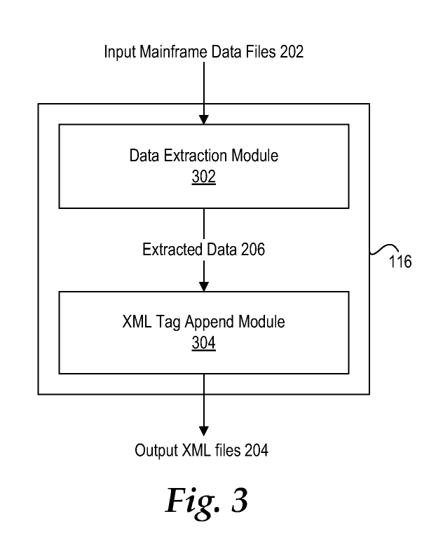

Referring now to FIG. 3, a block diagram illustrating the XML file generation module 116, in accordance with exemplary embodiments is provided. The XML file generation module 116 may generate the XML files 204 from the mainframe data files 202, as described in greater detail below. The XML file generation module 116 includes a data extraction module 302 and an XML tag append module 304, according to exemplary embodiments.

The data extraction module 302 may receive mainframe data files 202 and extract data, such as the data 206, to be tagged by the XML tag append module 304. In one embodiment, the data extraction module 302 extracts data from the one or more mainframe data files 202 according to one or more selection criteria. The data extraction module 302 may include Multiple Virtual Storage (“MVS”) Data Set Management Utilities (hereinafter “MVS Utilities”) from INTERNATIONAL BUSINESS MACHINES CORPORATION.

The MVS Utilities provide a number of predefined data management routines for, among other things, parsing data from a data set, such as the one or more mainframe data files 202, according to one or more selection criteria. Illustrative routines in the MVS Utilities for performing such parsing include SyncSort, Cobal, and the like. The extracted data 206 output by the data extraction module 302 is input into the XML tag append module 304 for appending XML tags, such as the XML tags 208. The XML tag append module 304 appends XML tags 208 to the extracted data to create the XML files 204. As discussed above, the XML tags 208 may be provided by a user of the system 100 via, for example, the input/output device 108 of system 100 or provided by a remote system via, for example, the network 118. Moreover, the XML tags 208 may be retrieved from the data 206 themselves of the mainframe data files 202.

Once the XML files 204 are generated, the XML files 204 may be sent to one or more end users over the network 118 of FIG. 1. According to embodiments, the end users need not have any prior knowledge of databases to build and prepopulate a database with the XML files 204 because the XML tags 208 associated with the data sets in the XML files 204 provide the database with sufficient information to dynamically build and populate the database, later amend the database, and even delete information from the database.

Further, the end users need not even have knowledge of the data in the XML files 204. In one embodiment, the end user may perform a draw of the data in the XML files 204 to view the fields of the prepopulated database. If the user is interested in one or more fields, the user may retrieve the information using the prepopulated database. For example, if the user views a “revenue” field in the prepopulated database and is interested in the associated revenue data, the user may generate a report using the revenue data.

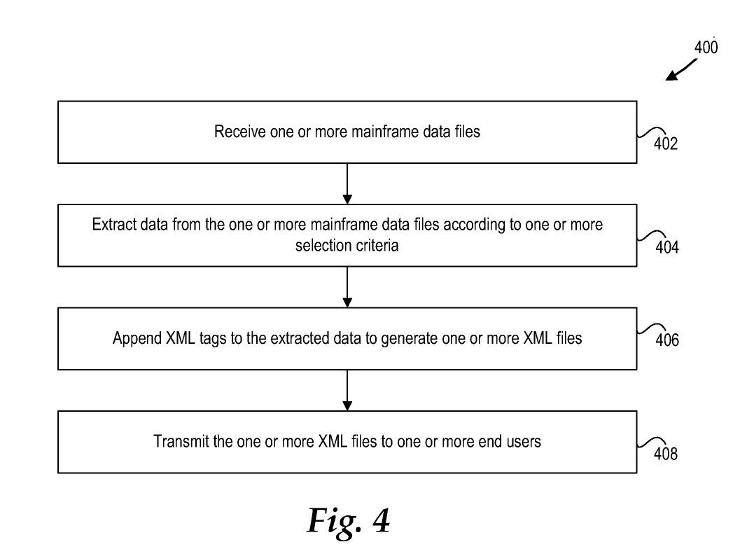

FIG. 4 is a flow diagram illustrating a method 400 of generating the XML files 204 from the mainframe data files 202, in accordance with exemplary embodiments. Reference will be made to FIGS. 1-4. The system 100, and in particular, the XML file generation module 116, receives (at 402) the mainframe data files 202. In one embodiment, the mainframe data files 202 are received via the network 118. Once the mainframe data files 202 are received, the mainframe data files 202 are stored in the memory 104, according to exemplary embodiments. As previously described, the mainframe data files 202 may include one or more sets of generally unorganized data gathered from any suitable mainframe, such as, but not limited to, an IBM MVS mainframe. The mainframe data files 202 are not suitable for prepopulating a database without further processing, according to exemplary embodiments.

The data extraction module 302 of the XML file generation module 116 extracts (at 404) data from the mainframe data files 202 according to one or more selection criteria. In one embodiment, the data is extracted utilizing MVS utilities, such as, but not limited to, SyncSort and/or Cobalt. The data extraction module 302 outputs the extracted data to the XML tag append module 304.

The XML tag append module 304 appends (at 406) XML tags 208 to the extracted data to generate the XML files 204. In one embodiment, the XML tags 208 appended to the extracted data are selected according to one or more criteria from an end user. In further embodiments, the XML tags 208 appended to the extracted data are selected based on information gathered from the extracted data itself. For example, a sequence of numbers in the extracted data may indicate a telephone number. Thus, the XML tags 208 are appended to the sequence of numbers associating the sequence of numbers with a telephone number. According to exemplary embodiments, the XML files 204 are stored in the memory 104.

The system 100 transmits (at 408) the XML files 204 to one or more end users via the network 118. The end users may dynamically build and prepopulate a database utilizing the XML files 204. For example, OFFICE ACCESS from MICROSOFT CORPORATION provides an “import” function by which an end user may build and prepopulate a database by importing the XML files 204.

Embodiments described and illustrated with reference to the Figures provide methods, systems, and computer-readable media for generating XML files from mainframe data. One or more embodiments assist in eliminating the traditional database development process, which may include using a database expert separate from the end user to build the database and to develop customized forms in which the end user enters the mainframe data. The one or more embodiments enable the end user to dynamically build and populate a database on the end user's own personal computer without the aid of the database expert and without customized forms.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

What is claimed is:

1. A method for generating Extensible Markup Language (XML) files from mainframe data, comprising:
receiving at least one mainframe data file;
extracting data from the at least one mainframe data file according to at least one selection criteria; and
appending at least one XML tag to the extracted data to generate at least one XML file.

2. The method of claim 1, further comprising:
transmitting the at least one XML file to at least one end user over a network.

3. The method of claim 1, wherein the at least one mainframe data file comprises unstructured data unsuitable for prepopulating a database.

4. The method of claim 1, wherein extracting data from the at least one mainframe data file according to at least one selection criteria comprises executing a multiple virtual storage (MVS) utility on the at least one mainframe data file.

5. The method of claim 4, wherein the MVS utility comprises SyncSort.

6. The method of claim 1, wherein the at least one XML tag appended to the extracted data is selected according to one or more criteria from at least one end user.

7. The method of claim 1, wherein the at least one XML tag appended to the extracted data is selected according to information in the extracted data.

8. A system for generating Extensible Markup Language (XML) files from mainframe data, comprising:
a memory for storing a program containing code for generating XML files from mainframe data;
a processor functionally coupled to the memory, the processor being responsive to computer-executable instructions contained in the program and operative to:
receive at least one mainframe data file;
extract data from the at least one mainframe data file according to at least one selection criteria; and
append at least one XML tag to the extracted data to generate at least one XML file.

9. The system of claim 8, wherein the processor is further operative to transmit the at least one XML file to at least one end user over a network.

10. The system of claim 8, wherein the at least one mainframe data file comprises unstructured data unsuitable for prepopulating a database.

11. The system of claim 8, wherein the data is extracted from the at least one mainframe data file by executing a multiple virtual storage (MVS) utility on the at least one mainframe data file.

12. The system of claim 8, wherein the at least one XML tag appended to the extracted data is selected according to one or more criteria from at least one end user.

13. The system of claim 8, wherein the at least one XML tag appended to the extracted data is selected according to information in the extracted data.

14. A computer-readable medium having instructions stored thereon for execution by a processor to perform a method for generating Extensible Markup Language (XML) files from mainframe data, the method comprising:
receiving at least one mainframe data file;
extracting data from the at least one mainframe data file according to at least one selection criteria; and
appending at least one XML tag to the extracted data to generate at least one XML file.

15. The computer-readable medium of claim 14, wherein the method further comprises:
transmitting the at least one XML file to at least one end user over a network.

16. The computer-readable medium of claim 14, wherein the at least one mainframe data file comprises unstructured data unsuitable for prepopulating a database.

17. The computer-readable medium of claim 14, wherein extracting data from the at least one mainframe data file according to at least one selection criteria comprises executing a multiple virtual storage (MVS) utility on the at least one mainframe data file.

18. The computer-readable medium of claim 17, wherein the MVS utility comprises SyncSort.

19. The computer-readable medium of claim 14, wherein the at least one XML tag appended to the extracted data is selected according to one or more criteria from at least one end user.

20. The computer-readable medium of claim 14, wherein the at least one XML tag appended to the extracted data is selected according to information in the extracted data.
